(19) United States
(12) Patent Application Publication
(10) Pub. No.: US 2026/0075535 A1
(43) Pub. Date: Mar. 12, 2026

(54) ELECTRONIC DEVICE AND METHOD FOR ADJUSTING TRANSMISSION POWER OF ANTENNA GROUP BY USING SAME

(71) Applicant: SAMSUNG ELECTRONICS CO., LTD., Suwon-si (KR)

(72) Inventors: Jaemoon CHA, Suwon-si (KR); Minha KIM, Suwon-si (KR); Yonghoon KWON, Suwon-si (KR); Euichang JUNG, Suwon-si (KR)

(73) Assignee: SAMSUNG ELECTRONICS CO., LTD., Suwon-si (KR)

(21) Appl. No.: 19/392,529

(22) Filed: Nov. 18, 2025

Related U.S. Application Data
(63) Continuation of application No. PCT/KR2024/005144, filed on Apr. 17, 2024.

(30) Foreign Application Priority Data
May 24, 2023 (KR) 10-2023-0066962
Jul. 11, 2023 (KR) 10-2023-0089945

(51) Int. Cl. H04W 52/06; H04W 52/18

(52) U.S. Cl. CPC H04W 52/06; H04W 52/18

(57) ABSTRACT

An electronic device includes: at least one first antenna included in a first antenna group; at least one second antenna included in a second antenna group; a communication circuit operatively connected to the at least one first antenna and the at least one second antenna; a sensor; a memory; and a processor connected to the communication circuit, the sensor, and the memory. The electronic device may identify the state of the electronic device by using the sensor based on a call reception. The processor may identify whether a power control condition configured for at least one of the first antenna group and the second antenna group is satisfied. The processor may adjust a transmission power supplied to at least one antenna included in an antenna group in which a power control condition is satisfied in response to a situation in which the power control condition is satisfied.

### CROSS-REFERENCE TO RELATED APPLICATIONS

This application is a continuation of International Application No. PCT/KR2024/005144, filed on Apr. 17, 2024, which is based on and claims priority to Korean Patent Application No. 10-2023-0066962, filed on May 24, 2023, and Korean Patent Application No. 10-2023-0089945, filed on Jul. 11, 2023, in the Korean Intellectual Property Office, the disclosures of which are incorporated by reference herein in their entireties.

### BACKGROUND

### 1. Field

The disclosure relates to an electronic device and a method of adjusting a transmission power of an antenna group using the electronic device.

### 2. Description of Related Art

An electronic device (e.g., user equipment (UE), smartphone) that supports wireless communication may transmit electromagnetic waves (e.g., wireless communication signal) in order to transmit data to or receive data from a base station. For example, electromagnetic waves may be harmful to a human body, and particularly, the harmful effects may become more severe when an electronic device is close to the human body. Due to the adverse effects of the electromagnetic waves, various organizations in the world have established utilization standards (e.g., specific absorption rate (SAR) regulations, electromagnetic wave absorption rate regulations, power density (PD) regulations) to limit electromagnetic waves to a selected level.

The above-described information may be provided for the purpose of helping understanding of the disclosure. There is no opinion or determination suggested in association with whether any of the above description is applicable to technology related to the disclosure.

### SUMMARY

Electromagnetic waves that may affect the human body may be determined based on an SAR or power density (PD). For example, the SAR may be a numerical value indicating how much electromagnetic waves (or electromagnetic energy), emitted from an electronic device (e.g., mobile communication terminal, smartphone) are absorbed by the human body. For example, the SAR is expressed in W/kg (or mW/g), and may include the amount of power (kW, W, or mW) absorbed per 1 g of the human body. Generally, an electronic device may be configured (or set) to perform wireless communication without exceeding the SAR reference value (e.g., approximately 1.6 W/Kg under SAR regulations). For example, when electromagnetic waves exceeding the SAR reference value are generated from an electronic device that supports wireless communication, the electronic device may at least partially limit the wireless communication or may block (e.g., power off) the wireless communication.

According to an embodiment of the disclosure, in addition to the SAR reference value, a power density (PD) may be used to identify whether the amount of electromagnetic waves exceeds the allowable limit in the case of electromagnetic waves in the mmW band that is not absorbed by the human body. For example, since the mmW is not absorbed, the PD may be measured based on the amount of electromagnetic waves per unit area. For example, according to Federal Communications Commission (FCC) regulations, it is approximately 10 W/m² which is an electromagnetic waves measurement of 10 W per area (m²).

In the case of an electronic device including a plurality of antennas (e.g., antenna group), transmission power may be limited to comply with regulations related to human body absorption rates or power density (PD) of electromagnetic waves per area. For example, the regulations related to the human body absorption rates may include SAR regulations based on a specific absorption rate (SAR) in the case of a band of approximately 6 GHz or less, and may include a power density (PD) per area in the case of an mmW band that is not absorbed by the human body.

According to an embodiment of the disclosure, the electronic device may perform an operation (e.g., SAR backoff operation) of limiting transmission power (Tx power) according to SAR regulations (e.g., SAR reference value) or power density (PD) reference value (e.g., power density). According to an embodiment of the disclosure, the PD reference value may be determined based on electromagnetic waves emitted from each of the six areas obtained by dividing the electronic device into six areas (e.g., area S1, area S2, area S3, area S4, area S5, and area S6). The PD reference value may be determined according to the following equation.

$${PD}_{surface} = max \{ {PD}_{s 1} , {PD}_{s 2} , {PD}_{s 3} , {PD}_{s 4} , {PD}_{s 5} , {PD}_{s 6} \} \qquad [ Equation 1 ]$$

For example, PDₛ₁ denotes electromagnetic waves measured based on area S1 of the electronic device. The electronic device may determine, to be the PD reference value, the maximum value among the electromagnetic waves (e.g., PDₛ₁ to PDₛ₆) measured based on each area.

For example, when performing wireless communication (e.g., call reception) using a plurality of antennas (e.g., antenna group), the electronic device may output electromagnetic waves generated based on the plurality of antenna groups, and may determine whether to perform (e.g., apply) a power control operation (e.g., SAR backoff operation) in batch with respect to the plurality of antenna groups in consideration of regulations on the human body absorption rates (e.g., SAR regulations) or power density reference value (e.g., PD). For example, the SAR backoff operation may include an operation of reducing emission of electromagnetic waves that may affect the human body by decreasing transmission power to a selected level (e.g., to be less than a configured threshold value).

Generally, when a call reception event occurs, the electronic device may assume a situation in which the electronic device is positioned close to a body part (e.g., head) of a user, and may perform a power control operation based on at least one antenna included in the electronic device. The power control operation may include, for example, the SAR backoff operation. For example, the SAR backoff operation may include an operation of reducing transmission power of an antenna included in the electronic device to a selected level. In another embodiment, when a user is on a call using a speakerphone, the electronic device may not be positioned close to the head of the user. In this instance, a power control operation may not be required. When a power control operation is performed, communication performance may unnecessarily deteriorate. According to an embodiment of the disclosure, conditions for performing a power control operation may be specifically defined so as to prevent a power control operation from being performed when communication performance unnecessarily occurs. For example, when a user is on a call using a speakerphone in the electronic device, a power control operation (e.g., SAR backoff operation) may be an unnecessary operation that deteriorates wireless communication performance. According to an embodiment, a situation that requires application of an SAR backoff operation and a situation that does not need application of an SAR backoff operation may be specifically distinguished.

According to an embodiment, in relation to a plurality of antennas (e.g., antenna group) included in the electronic device, a power control operation may be configured to be different for each antenna. For example, a power control operation may include an SAR event according to SAR regulations (e.g., an event in which application or non-application of an SAR backoff operation occurs.)

The technical subject matter of the document is not limited to the above-mentioned technical subject matter, and other technical subject matters which are not mentioned may be understood by those skilled in the art based on the following description.

According to an aspect of the disclosure, an electronic device includes: at least one first antenna included in a first antenna group; at least one second antenna included in a second antenna group different from the first antenna group; a communication circuit operatively connected to the at least one first antenna and the at least one second antenna; a sensor; a memory storing instructions; and at least one processor connected to the communication circuit, the sensor, and the memory, wherein the instructions, when executed by the at least one processor individually or collectively, cause the electronic device to: identify, by using the sensor, a state of the electronic device, based on a call reception via the communication circuit; during the call reception, identify whether a power control condition configured for at least one of the first antenna group and the second antenna group is satisfied, based on the state of the electronic device; and based on identifying that the power control condition is satisfied, adjust a transmission power of a signal transmitted via at least one antenna included in an antenna group that satisfies the power control condition from among the first antenna group or the second antenna group.

According to an aspect of the disclosure, a method of operating an electronic device, includes: based on a call reception, identifying a grip state of the electronic device, using a sensor of the electronic device; during the call reception, identifying whether a power control condition configured for at least one of a first antenna group and a second antenna group of the electronic device is satisfied, based on the identified grip state; and based on identifying that the power control condition is satisfied, adjusting a transmission power of a signal transmitted via at least one antenna included in an antenna group that satisfies the power control condition from among the first antenna group and the second antenna group.

According to an aspect of the disclosure, a non-transitory computer-readable storage medium (or computer program product) storing one or more programs including which, when executed by the programs of an electronic device, perform the method.

According to an embodiment, an electronic device may configure a power control condition for each of a plurality of antenna (e.g., antenna group), individually. The electronic device may determine whether to perform a power control operation (e.g., SAR backoff operation) in consideration of various situations. According to an embodiment, since various situations are taken into consideration, a situation that applies a power control operation and a situation that does not apply a power control operation may be distinguished, and an unnecessarily performed power control operation may be prevented and a situation that deteriorates communication performance may be prevented. The various situations may include a situation that does not require a power control operation (e.g., the case of no grip after a received call, the case in which the electronic device is not disposed close to a body part (e.g., head) of a user). According to an embodiment, unnecessary application/non-application of a power control operation (e.g., SAR backoff operation) may be prevented.

According to an embodiment, the electronic device may configure a first condition (e.g., head event) that the electronic device is disposed close to the head of a user and a second condition (e.g., non-head event) that the electronic device is disposed a distance apart from the head of the user. When identifying grip in a situation in which a call is terminated, the electronic device may be controlled so that a power control operation may be applied as it is. According to an embodiment, by controlling the electronic device to perform or not to perform a power control operation according to various situations, the SAR reference value may be satisfied and a problem of deterioration in communication performance caused by unnecessary power down may be overcome. To meet the SAR reference value in various situations, power may be controlled, and situations that cause bad effects to the human body may be reduced. Safety associated with the use of the electronic device may be strengthened.

Effects that could be obtained based on the disclosure are not limited to the above-described effects, and those skilled in the art would clearly understand, based on the descriptions provided below, other effects which are not mentioned above.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram of an electronic device according to an embodiment of the disclosure;

FIG. 3 is a flowchart illustrating a method of configuring a power control condition for each antenna group according to an embodiment of the disclosure;

FIG. 4A is a diagram illustrating positions where a first antenna group and a second antenna group are disposed in an electronic device according to an embodiment of the disclosure;

FIG. 4B is a diagram illustrating positions where a first antenna group and a second antenna group are disposed in a foldable electronic device according to an embodiment of the disclosure;

FIG. 5A is a first graph representing an SAR value when no grip event occurs in a call reception situation according to an embodiment of the disclosure;

FIG. 5B is a second graph representing an SAR value when grip event occurs in a call reception situation according to an embodiment of the disclosure;

FIG. 5C is a third graph representing an SAR value when call reception is terminated in a situation in which a power control operation occurs in response to call reception according to an embodiment of the disclosure;

FIG. 5D is a fourth graph representing an SAR value when call reception is terminated in a situation in which a power control operation occurs (e.g., a state in which both head/non-head are configured) in response to call reception according to an embodiment of the disclosure;

FIG. 6 is a flowchart illustrating a method of identifying a power control condition for each antenna group according to an embodiment of the disclosure;

FIG. 7A is a first graph illustrating a power control condition based on a fixed value in relation to SAR regulations according to an embodiment of the disclosure; and

FIG. 7B is a second graph illustrating a power control condition based on an average value in relation to SAR regulations according to an embodiment of the disclosure.

### DETAILED DESCRIPTION

Hereinafter, embodiments of the disclosure will be described in detail with reference to enclosed drawings, so that those skilled in the art could readily implement the embodiments. However, the disclosure could be implemented in different manners, and is not limited to the embodiments described below. Identical or like reference numerals in the drawings denote identical or like elements. In addition, a description of a well-known function and configuration may be omitted in the drawings and related descriptions for clarity and simplicity.

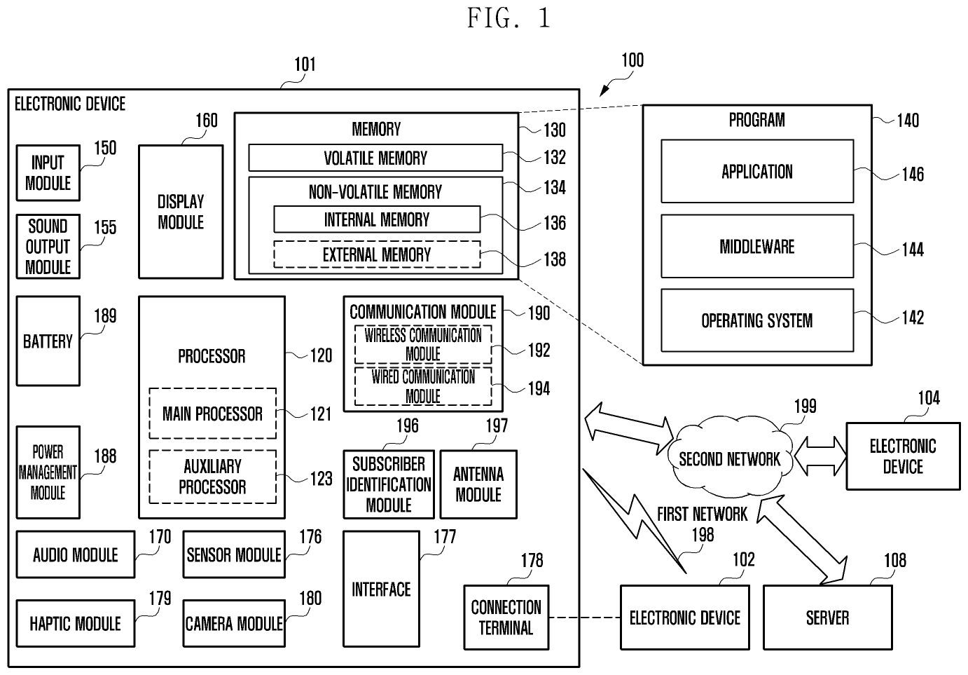

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) (e.g., a speaker or a headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). For example, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include a patch array antenna and/or a dipole array antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

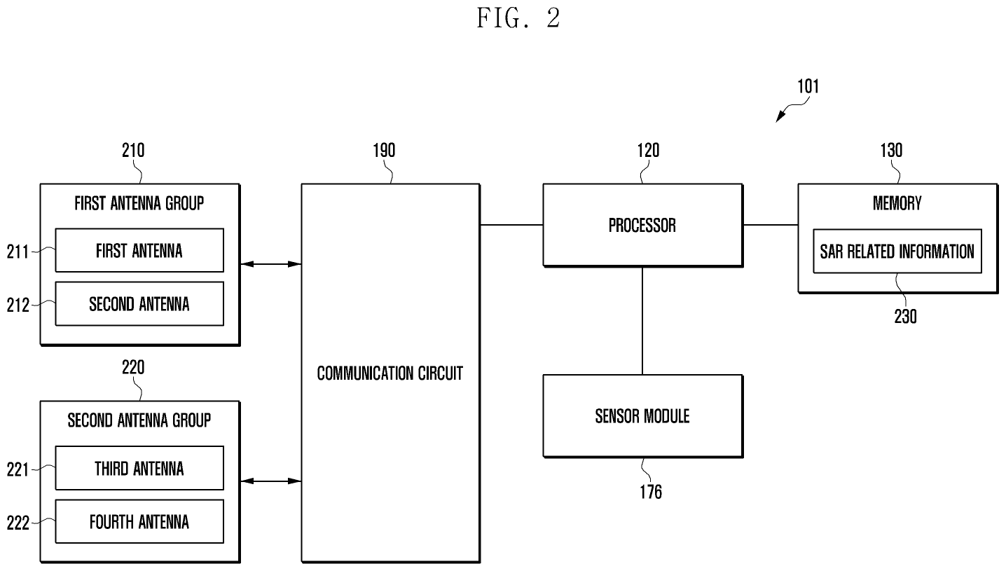

FIG. 2 is a block diagram of an electronic device according to an embodiment of the disclosure.

The electronic device 101 of FIG. 2 (e.g., the electronic device 101 of FIG. 1) may be at least partially similar to the electronic device 101 of FIG. 1, or may further include other embodiments of the electronic device 101.

The electronic device 101 may support various types of communication schemes, when supporting wireless communication. For example, the communication schemes may include communication schemes (or cellular schemes) such as a second generation 2G, a third generation (3G), a fourth generation (4G), a fifth generation (5G), and the like and communication schemes (or non-cellular schemes) such as wireless fidelity (Wi-Fi), Bluetooth (BT), and/or ultra-wideband (UWB). The electronic device 101 may perform communication by separately using each communication scheme or may perform communication by simultaneously using multiple communication schemes together.

The electronic device 101 may include at least one antenna group (e.g., first antenna group 210, second antenna group 220) including a plurality of antennas. For example, the at least one antenna group 210 or 220 may support the sub 6 Ghz frequency band, or may support the millimeter wave (mmW) frequency band. According to an embodiment, the electronic device 101 may configure (or set) a power control condition to be different for each of the plurality of antenna groups. For example, the electronic device 101 may configure (or set) a first power control condition for the first antenna group 210, and may configure (or set) a second power control condition for the second antenna group 220. According to an embodiment, the electronic device 101 may configure (or set) a power control condition to be different for each of a first antenna 211 and a second antenna 212 included in the first antenna group 210, and may control power for each antenna. According to an embodiment, the electronic device 101 may configure (or set) a power control condition to be different for each of a third antenna 221 and a fourth antenna 222 included in the second antenna group 220, and may control power for each antenna. According to an embodiment of the disclosure, the electronic device 101 may configure (or set) a power control condition to be different for each antenna group, or may configure (or set) a power control condition to be different for each of a plurality of antennas included in an antenna group. The electronic device 101 may individually configure (or set) a power control condition for each of the plurality of antennas.

According to an embodiment of the disclosure, the first antenna group 210 may be a group of antennas positioned in an upper side of the electronic device 101, and the second antenna group 220 may be a group of antennas positioned in a lower side of the electronic device 101. The number of antennas (e.g., first antenna 211, second antenna 212, third antenna 221, fourth antenna 222) included in each antenna group 210 or 220 may be greater or less than the number of antennas illustrated in the drawing, and is not limited to the description of the drawing.

According to an embodiment of the disclosure, each antenna may support a different network. For example, the first antenna group 210 may support a first cellular network, and the second antenna group 220 may support a second cellular network. According to an embodiment, the first cellular network may support at least one of a second generation (2G), a third generation (3G), a fourth generation (4G), or long term evolution (LTE) network. The second cellular network may support establishing a communication channel corresponding to a specified band (e.g., approximately 6 GHz to 60 GHz) to be used for wireless communication, and may support 5G network communication using the established communication channel. For example, the first antenna group 210 may include at least one antenna (e.g., first antenna 211, second antenna 212) capable of covering a 6 GHz band. For example, the second antenna group 220 may include an antenna (e.g., third antenna 221, fourth antenna 222) supporting the mmW frequency band. For example, a power control reference value may be a regulatory or design parameter that determines how much transmit power an antenna (or antenna group) is allowed to use under certain conditions. The power control reference value may include e.g., power control condition, reference SAR value related to SAR regulations. According to an embodiment, the power control reference value may be configured (or set) to be different for each antenna. According to an embodiment, the power control reference value may be configured (or set) to be different for each antenna group (e.g., first antenna group 210, second antenna group 220). For example, the electronic device 101 may adjust the power control condition of the antennas of the corresponding group together, or adjust the power control condition for each antenna individually.

As shown below, Table 1 provides an example in which a power control condition is configured (or set) to be different for each antenna group, or for each antenna.

TABLE 1

| | Antenna | Free | | Receive call | |
|---|---|---|---|---|---|
| Band | group | Non Head | Non Head | Non Head | Head |
| GSM | 0 | 25 | 25 | 27 | 32 |
| LTE_B1 | 0 | 21 | 21 | 27 | 27 |
| LTE_B2 | 8 | 20 | 20 | 20 | 15 |
| LTE_B3 | 0 | 21 | 21 | 21 | 14 |
| LTE_B4 | 8 | 30 | 30 | 30 | 25 |

Referring to Table 1, the first antenna group 210 (e.g., antenna group 0) positioned in an upper side of the electronic device 101 may include at least one antenna supporting a GSM band, a LTE_B1 band, and a LTE_B3 band. The second antenna group 220 (e.g., antenna group 8) positioned in a lower side of the electronic device 101 may include at least one antenna supporting an LTE_B2 band and an LTE_B4 band. Referring to Table 1, a threshold value (e.g., limit value) of a power control condition for each antenna may be configured (or set) to be different. For example, in response to a situation in which an SAR value for a selected antenna exceeds a threshold value in Table 1, the electronic device 101 may adjust a power value applied to the selected antenna. The electronic device 101 may adjust the power value applied to the selected antenna so that the SAR value for the selected antenna may be less than the threshold value.

According to an embodiment, in the case of a received call state in which the electronic device 101 receives a call request signal (e.g., call signal), the electronic device 101 may distinguish between a non-head state and a head state, and may configure (or set) a power control reference value corresponding to each antenna to be different for each state. For example, the electronic device 101 may control power for each antenna based on an SAR value (e.g., limit reference value) configured (or set) in Table 1.

According to an embodiment, the power control condition may include a reference value (e.g., SAR value) to determine whether to perform an SAR backoff operation in the electronic device 101. For example, in association with the first antenna group 210, when the first power control condition is configured (or set), the electronic device 101 may perform an SAR backoff operation for the first antenna group 210 in response to (based on) the first power control condition being satisfied. According to an embodiment of the disclosure, the power control condition may be classified as a first scheme in which a reference value (e.g., SAR value, threshold value) is defined in advance, and a second scheme (e.g., average SAR limit) in which a reference value continuously varies based on the TX power of a transmission signal. In the second scheme, the electronic device 101 may continuously check (or monitor) the TX power of the transmission signal, and may perform an SAR backoff operation so that a varying limit power value (e.g., SAR value) may not exceed a reference value (e.g., threshold value, reference value configured (or set) in Table 1). For example, the electronic device 101 may decrease (or reduce) transmission power (Tx power) applied to the first antenna group 210 to be less than a first SAR value, and may supply the reduced Tx power.

As another example, in association with the second antenna group 220, when the second power control condition is configured (or set), the electronic device 101 may perform an SAR backoff operation for the second antenna group 220 in response to (or based on) the second power control condition being satisfied. The electronic device 101 may decrease (or reduce) transmission power (Tx power) applied to the second antenna group 220 to be less than a second SAR value, and may supply the reduced Tx power.

According to an embodiment, the electronic device 101 may configure (or set) a power control condition for each of a plurality of antenna groups (e.g., first antenna group 210, second antenna group 220) included therein, and for each of at least one antenna (e.g., first antenna 211, second antenna 212, third antenna 221, fourth antenna 222) included in the antenna groups. For example, the electronic device 101 may control power according to a power control condition configured (or set) to be different for each antenna group 210 or 220, or for each antenna 211, 212, 221, or 222.

According to an embodiment, in response to call reception (e.g., received call (RCV)), the electronic device 101 may identify a power control condition (e.g., SAR event) corresponding to each antenna group, and may determine whether to apply (or perform) an SAR backoff operation for the corresponding antenna group. According to an embodiment of the disclosure, the power control condition (e.g., SAR event) may be triggered by various conditions identified by the electronic device 101, in order to perform or not to perform an SAR backoff operation. For example, whether the power control condition (e.g., SAR event) is satisfied or not may be determined by comparing the average value of measurement values with a limit average value (e.g., configured threshold value in Table 1) while the electronic device 101 continuously or periodically measures power of an antenna. When the power control condition is satisfied, the electronic device 101 may perform a power control operation that either decreases power of at least a portion of the plurality of antennas or increases power to maintain the current operating state.

According to an embodiment, upon call reception, the electronic device 101 may determine whether a power control condition is satisfied for each of the first antenna group 210 and the second antenna group 220, individually, and when the power control condition is satisfied, the electronic device 101 may perform an SAR backoff operation for the corresponding antenna group.

According to an embodiment, the electronic device 101 may configure (or set) an SAR event related to a call termination situation, and may determine whether to perform an SAR backoff operation in response to call termination.

According to an embodiment, the electronic device 101 may configure (or set), together, a head event (e.g., call reception situation) in which the electronic device 101 is positioned close to the head of a user and a non-head event (e.g., call termination situation) in which the electronic device 101 is at least a selected distance away from the head of the user. For example, the electronic device 101 may be configured (or set) to stop performing an SAR backoff operation or to maintain the SAR backoff operation in response to transition from a head event to a non-head event. As another example, the electronic device 101 may be configured (or set) to perform an SAR backoff operation in response to transition from a non-head event to a head event. The head event and the non-head event may be included as part of the power control condition (e.g., SAR event).

According to an embodiment, via various sensors corresponding to at least one of a grip sensor, an acceleration sensor, a camera, or a proximity sensor, the electronic device 101 may determine whether the electronic device 101 is in a state of being gripped by a user. The electronic device 101 may determine, in a manner of software, whether the electronic device 101 is gripped. According to an embodiment, the electronic device 101 may perform various sensing operations such as sensing grip, sensing a head and a non-head event, and sensing call reception, and the corresponding sensing operations may be included as part of the power control condition.

According to an embodiment, the electronic device 101 may configure (or set) a power control condition to be different for each of a plurality of antenna groups 210 and 220, or for each antenna 211, 212, 221, and 222, and in response to the power control condition being satisfied, may perform an SAR backoff operation for each antenna group or for each antenna, individually. According to an embodiment, a situation that violates the SAR standard (e.g., SAR regulations) may be prevented, and a situation that causes harmful effects to user's health due to violation of the SAR standard may be reduced. Safety of users may be enhanced.

According to an embodiment of the disclosure, by individually performing an SAR backoff operation with respect to each antenna group 210 or 220, or for each antenna 211, 212, 221, or 222, the electronic device 101 may prevent unnecessary SAR backoff operations. The electronic device 101 may maintain optimized communication performance without violating the SAR standard.

For example, when an SAR backoff operation is performed every time that a power control condition is satisfied, in order to comply with the SAR standard, without separately controlling each antenna group or each antenna, communication performance may deteriorate. To solve the problem, the electronic device 101 may divide antennas into groups or may individually control antennas disposed in an upper side of the electronic device 101 or antennas disposed in a lower side of the electronic device 101. The electronic device 101 may individually control power of each antenna (e.g., first antenna 211, second antenna 212, third antenna 221, or fourth antenna 222) based on whether a call is received, whether the electronic device 101 is gripped, or whether a head is close to the electronic device 101 (e.g., head condition, non-head condition).

Referring to FIG. 2, the electronic device 101 may include a processor (e.g., the processor 120 of FIG. 1), a memory (e.g., the memory 130 of FIG. 1), a sensor module (e.g., sensor module 176 of FIG. 1), a communication circuit (e.g., the communication module 190 of FIG. 1), and/or a plurality of antenna groups (e.g., the first antenna group 210 and the second antenna group 220). For example, each of the plurality of antenna groups 210 and 220 may include at least one antenna, and may be operatively or electrically connected to the communication circuit 190. The first antenna group 210 may include the first antenna 211 and the second antenna 212, and the second antenna group 220 may include the third antenna 221 and the fourth antenna 222.

According to an embodiment, the processor 120 of the electronic device 101 may execute a program (e.g., the program 140 of FIG. 1) stored in the memory 130, may control at least one other component (e.g., hardware or software component), and may execute various data processing or operations. For example, based on SAR related information 230 stored in the memory 130, the processor 120 may perform an SAR backoff operation with respect to at least one of the first antenna group 210 and the second antenna group 220, or at least one of the first antenna 211 and the second antenna 212 included in the first antenna group 210, and the third antenna 221 and the fourth antenna 222 included in the second antenna group 220. For example, the SAR backoff operation may include an operation of limiting transmission power (Tx power) of a signal transmitted via at least one antenna to be less than a previously configured SAR value (e.g., a value configured not to violate the SAR regulations, configured threshold value in Table 1), and an operation of measuring an average power value and adjusting power based on the average power value. According to an embodiment, the electronic device 101 may control transmission power (Tx power) for at least one antenna within a range in which the power control condition (e.g., SAR regulations) is satisfied. According to an embodiment, the processor 120 may be operatively, functionally, and/or electrically connected to the memory 130, the sensor module 176, and/or the communication circuit 190.

According to an embodiment of the disclosure, the electronic device 101 may measure transmission power (Tx power) at a plurality of points in time, and may need to keep a cumulative SAR measured during a measurement time to be less than or equal to a maximum cumulative SAR value (e.g., MAX SAR). For example, the electronic device 101 may determine transmission power (Tx power) of antennas so that a cumulative SAR value at the current point in time and past points in time and a cumulative SAR value at a future point in time may be less than or equal to the maximum cumulative SAR value.

According to an embodiment, the memory 130 may include specific absorption rate (SAR) related information 230. For example, the SAR related information 230 may include an SAR value that satisfies the SAR regulations (e.g., power control condition) under a selected condition. For example, in a situation (e.g., head condition) in which the electronic device 101 is positioned close to a body part (e.g., specifically, a head), an SAR backoff operation may be performed in order to reduce generation of electromagnetic waves, and the SAR related information 230 may include an SAR value associated with the SAR backoff operation. The SAR backoff operation may include an operation of decreasing (or reducing) transmission power (Tx power) of a signal transmitted via at least one antenna to be less than a configured SAR value. According to an embodiment, in response to a situation (e.g., call reception situation, head condition) in which the electronic device 101 is positioned close to the head of a user, the electronic device 101 may perform the SAR backoff operation based on the SAR related information 230. The electronic device 101 may perform an SAR backoff operation according to the SAR regulations so as to prevent electromagnetic waves from causing harmful effects to the human body.

According to an embodiment, the electronic device 101 may include a plurality of antennas (e.g., at least one first antenna 211, at least one second antenna 212, at least one third antenna 221, and at least one fourth antenna 222) which are divided into the first antenna group 210 and the second antenna group 220. For example, the first antenna group 210 and the second antenna group 220 may be distinguished based on the positions where they are disposed in the electronic device 101. The first antenna group 210 may be at least partially disposed in an upper side (e.g., upper portion, upper lateral side) of the electronic device 101 where a speaker is disposed, and the second antenna group 220 may be at least partially disposed in a lower side (e.g., lower portion, lower lateral side) where a microphone is disposed, and which is in the opposite direction to the upper side. According to an embodiment, when a user receives a call, and grips the electronic device 101, the first antenna group 210 may be positioned relatively close to the head of the user, and the second antenna group 220 may be positioned at least a selected distance away from the head of the user. For example, the first antenna group 210 may be positioned close to an ear of the user, and the second antenna group 220 may be positioned close to the mouth of the user.

According to an embodiment, when the user receives a call, and grips the electronic device 101, the first antenna group 210 may be positioned close to the head of the user, and thus electromagnetic waves emitted from the first antenna group 210 may directly give harmful effects on the user. According to an embodiment, the electronic device 101 may preferentially configure, for the first antenna group 210, a power control condition (e.g., SAR event) in association with call reception, and may perform an SAR backoff operation in response to call reception so that transmission power (Tx power) of a signal transmitted via the first antenna group 210 may be decreased (or reduced).

According to an embodiment, when the user receives a call, and grips the electronic device 101, the second antenna group 220 may be positioned close to the mouth of the user, and thus electromagnetic waves emitted from the second antenna group 220 may relatively give harmful effects on the user. According to an embodiment, the electronic device 101 may preferentially configure, for the second antenna group 220, a power control condition (e.g., SAR event) in association with whether a grip event occurs during call reception, and may perform an SAR backoff operation in response to a grip state during call reception so that transmission power (Tx power) supplied to the second antenna group 220 may be decreased (or reduced).

According to an embodiment, the electronic device 101 may configure (or set) a first power control condition (e.g., event based on call reception) for the first antenna group 210, and may configure (or set) a second power control condition (e.g., event based on whether a grip event occurs during call reception) for the second antenna group 220, which is different from the first power control condition. For example, the first antenna group 210 may perform an SAR backoff operation in response to satisfaction of the first power control condition, and the second antenna group 220 may perform an SAR backoff operation in response to satisfaction of the second power control condition. The electronic device 101 may configure (or set) a different power control condition for each antenna group or for each antenna.

According to an embodiment, the first antenna group 210 may include at least one first antenna 211 and at least one second antenna 212, and the second antenna group 220 may include at least one third antenna 221 and at least one fourth antenna 222. The electronic device 101 may configure (or set) a different power control condition for each antenna 211, 212, 221, or 222.

According to an embodiment, the communication circuit 190 may be operatively or electrically connected to the first antenna group 210 and the second antenna group 220. The processor 120 may supply transmission power (Tx power) to the first antenna group 210 and the second antenna group 220 via the communication circuit 190, and may transmit or receive a communication signal via the first antenna group 210 and the second antenna group 220. The processor 120 may supply transmission power (Tx power) individually to the first antenna group 210 and the second antenna group 220. For example, the processor 120 may identify the first power control condition (e.g., first SAR event) configured (or set) for the first antenna group 210, and may perform an SAR backoff operation for the first antenna group 210 in response to satisfaction of the first power control condition. Based on the SAR backoff operation, the processor 120 may adjust the transmission power (Tx power) of a signal transmitted via the first antenna group 210. As another example, the processor 120 may identify the second power control condition (e.g., second SAR event) configured (or set) for the second antenna group 220, and may perform an SAR backoff operation for the second antenna group 220 in response to satisfaction of the second power control condition. Based on the SAR backoff operation, the processor 120 may adjust the transmission power (Tx power) of a signal transmitted via the second antenna group 220.

According to an embodiment, the sensor module 176 may use a grip sensor to detect whether the electronic device 101 is gripped and/or various other sensor modules 176 to detect whether the electronic device 101 is at least partially close to a body part. For example, the various sensor modules 176 may include at least one sensor for determining whether a user grips the electronic device 101, such as a proximity sensor and a grip sensor. The processor 120 may determine, by using the grip sensor, whether the electronic device 101 is in a grip state. The processor 120 may determine, by using the proximity sensor, whether the electronic device 101 is at least partially close to a body part. According to an embodiment, in response to call reception, the processor 120 may determine whether the electronic device 101 is in a grip state or non-grip state by using the sensor module 176. According to an embodiment, in response to call reception, the processor 120 may determine, by using the sensor module 176, whether it is a head condition in which the electronic device 101 is disposed close to the head of a user within a selected distance or whether it is a non-head condition in which the electronic device 101 is disposed at least a selected distance away from the head. In another example, the non-head condition may correspond to the electronic device 101 being disposed beyond or outside the selected distance from the head of the user.

According to an embodiment, the electronic device 101 may configure (or set) a power control condition (e.g., SAR event) to be different for each of a plurality of antenna groups (e.g., first antenna group 210, second antenna group 220). For example, the processor 120 of the electronic device 101 may configure (or set) a call reception event (e.g., RCV) as an SAR event for the first antenna group 210, and may configure (or set) a grip-related event (e.g., Grip ON or Grip OFF) as an SAR event for the second antenna group 220. According to an embodiment, the power control condition may include a condition in which a call reception state (e.g., RCV ON) is changed to a hotspot state. For example, the electronic device 101 may detect a change to a hotspot state, and may perform an SAR backoff operation in response to the change to the hotspot state.

According to an embodiment of the disclosure, the electronic device 101 may configure (or set) a situation of a change from RCV ON to Hotspot ON as a power control condition (e.g., SAR event).

According to an embodiment, upon call reception, the processor 120 may determine that an SAR event is satisfied for the first antenna group 210, and may perform an SAR backoff operation for the first antenna group 210. According to an embodiment, when the electronic device 101 receives a call in a grip state, the processor 120 may determine that a power control condition (e.g., SAR event) is satisfied for the second antenna group 220, and may perform an SAR backoff operation for the second antenna group 220. The electronic device 101 may configure (or set) a power control condition (e.g., SAR event) individually for each of a plurality of antenna groups, and may independently perform an SAR backoff operation for each antenna group.

According to an embodiment, the electronic device 101 may configure (or set) a power control condition (e.g., SAR event) individually for each antenna 211, 212, 221, or 222 included in the plurality of antenna groups 210 and 220, and may independently perform an SAR backoff operation for each antenna. According to an embodiment of the disclosure, based on whether a power control condition is satisfied, an operation of increasing or decreasing power of each antenna may be performed.

According to an embodiment, the processor 120 may configure (or set) a first condition (e.g., head event) in which the electronic device 101 is disposed close to the head of a user and a second condition (e.g., non-head event) in which the electronic device 101 is disposed at least a selected distance away from the head of the user, together. In another example, the second condition (e.g., non-head event) may correspond to the electronic device 101 being disposed beyond or outside the selected distance from the head of the user. For example, although a situation in which the first condition (e.g., head event) is changed to the second condition (e.g., non-head event) in response to termination of call reception, the processor 120 may maintain an SAR backoff operation for the plurality of antenna groups 210 and 220 or for individual antennas 211, 212, 221, and 222. Although the electronic device 101 is spaced at least a selected distance apart from the head of the user, the processor 120 may continuously perform the SAR backoff operation.

According to an embodiment, the electronic device 101 may apply or may not apply an SAR backoff operation in consideration of various situations, thereby reducing violation of the SAR standard. Since violation of the SAR standard less frequently occurs, situations that cause harmful effects to the human body may less frequently occur. Safety in association with the use of the electronic device 101 may be improved.

According to an embodiment, an electronic device (e.g., the electronic device 101 of FIG. 1) may include at least one first antenna (e.g., the first antenna 211 of FIG. 2) included in a first antenna group (e.g., the first antenna group 210 of FIG. 2), at least one second antenna (e.g., the third antenna 221 of FIG. 2) included in a second antenna group (e.g., the second antenna group 220 of FIG. 2), different from the first antenna group 210, a communication circuit (e.g., the communication module 190 of FIG. 1) operatively connected to the at least one first antenna 211 and the at least one second antenna 221, a sensor module (e.g., the sensor module 176 of FIG. 1), a memory (e.g., the memory 130 of FIG. 1), and a processor (e.g., the processor 120 of FIG. 1) operatively connected to the communication circuit 190, the sensor module 176, and the memory 130. The processor 120 may identify a state (e.g., grip ON state, grip OFF state) of the electronic device 101 by using the sensor module 176 in response to call reception via the communication circuit 190. The processor 120 may identify whether a power control condition corresponding to at least one of the first antenna group 210 and the second antenna group 220 is satisfied based on the identified state of the electronic device 101 when call reception is performed. The processor 120 may adjust the transmission power (Tx power) of a signal transmitted via at least one antenna included in an antenna group that satisfies the power control condition in response to a situation in which the power control condition is satisfied.

According to an embodiment, the processor 120 may identify a first power control condition configured (or set) for the at least one first antenna 211 included in the first antenna group 210. The processor 120 may determine, based on the state of the electronic device 101 when call reception is performed, whether the first antenna group 210 satisfies the first power control condition.

According to an embodiment, the processor 120 may identify a second power control condition configured (or set) for the at least one second antenna 221 included in the second antenna group 220. The processor 120 may determine, based on the state of the electronic device 101 when call reception is performed, whether the second antenna group 220 satisfies the second power control condition.

According to an embodiment, the processor 120 may determine a first transmission power to be less than a configured SAR threshold value when the first power control condition corresponding to the first antenna group 210 is satisfied. The processor 120 may transmit a signal having the first transmission power via the at least one first antenna 211 included in the first antenna group 210.

According to an embodiment, the processor 120 may determine a second transmission power to be less than a configured SAR threshold value when the second power control condition corresponding to the second antenna group 220 is satisfied. The processor 120 may transmit a signal having the second transmission power via the at least one second antenna 221 included in the second antenna group 220.

According to an embodiment, the sensor module 176 of the electronic device 101 may further include a grip sensor. The processor 120 may identify whether the electronic device 101 is in a grip state when performing call reception, by using the grip sensor. The processor 120 may adjust the transmission power (Tx power) of a signal transmitted via at least one antenna included in the first antenna group 210 and the second antenna group 220 in response to the grip state. According to an embodiment, the processor 120 may identify call termination in a situation in which a signal having the adjusted transmission power (Tx power) is transmitted via the at least one antenna. The processor 120 may maintain the transmission power (Tx power) of the signal transmitted via the at least one antenna in response to the grip state being maintained.

According to an embodiment, the call reception may include a first condition in which the electronic device 101 is disposed within a configured distance from the head of a user. The call termination may include a second condition in which the electronic device 101 is disposed at least a configured distance away from the head of the user.

According to an embodiment, the processor 120 may configure (or set) the first condition and the second condition together as the power control condition. In response to the call reception, the processor 120 may adjust the transmission power (Tx power) of a signal transmitted via the at least one antenna. In response to the call termination, the processor 120 may maintain the adjusted transmission power (Tx power) of a signal transmitted via the at least one antenna.

According to an embodiment, the first antenna group 210 may include the at least one first antenna 211 disposed within a configured distance from the head of the user in response to a situation in which the electronic device 101 is gripped when the call reception is performed. The second antenna group 220 may include the at least one second antenna 221 disposed at least a configured distance away from the head of the user in response to a situation in which the electronic device 101 is gripped when the call reception is performed.

According to an embodiment, each of the first antenna group 210 and the second antenna group 220 may be configured with a power control condition, individually. The processor 120 may adjust the transmission power (Tx power) of a signal transmitted via at least one antenna, independently, in response to a situation in which the power control condition is satisfied.

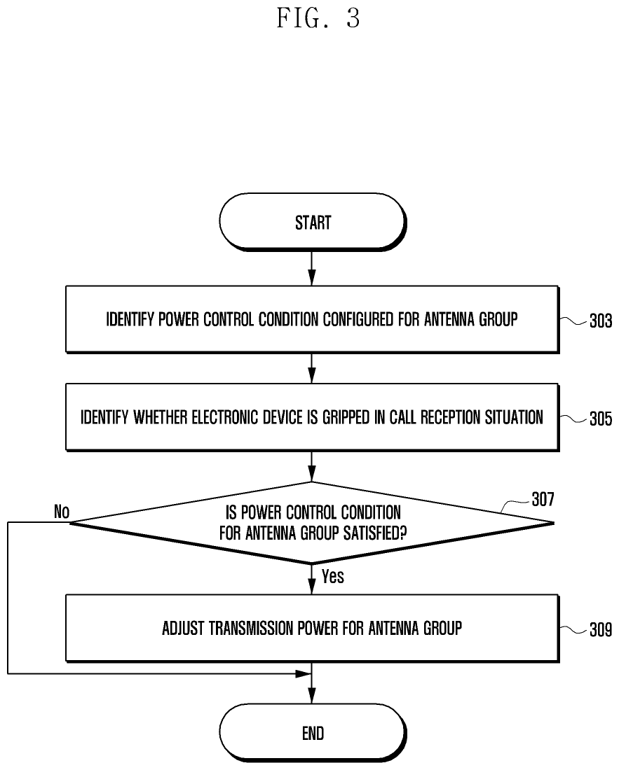

FIG. 3 is a flowchart illustrating a method of configuring a power control condition for each antenna group according to an embodiment of the disclosure.

In the following embodiment, operations may be performed sequentially, but the order is not necessarily sequential. For example, the order of operations may be changed, and at least two operations may be performed in parallel.

According to an embodiment, it may be understood that operations 301 to 309 are performed by a processor (e.g., the processor 120 of FIGS. 1 and 2) of an electronic device (e.g., the electronic device 101 of FIGS. 1 and 2).

The electronic device 101 of FIG. 3 may be at least partially similar to the electronic device 101 of FIG. 1, or may further include other embodiments of the electronic device 101. The electronic device 101 may include a plurality of antenna groups (e.g., the first antenna group 210 and the second antenna group 220 of FIG. 2), and may determine whether to perform an SAR backoff operation based on at least one of the antennas included in the plurality of antenna groups 210 and 220. The first antenna group 210 may include the first antenna 211 and the second antenna 212, and the second antenna group 220 may include the third antenna 221 and the fourth antenna 222.

According to an embodiment, the electronic device 101 may configure (or set) a power control condition (e.g., SAR event) to be different for each of a plurality of antenna groups (e.g., the first antenna group 210, the second antenna group 220), or for each antenna 211, 212, 221, or 222. For example, the power control condition (e.g., SAR event) may be a reference condition for performing an SAR backoff operation. For example, a call reception event (e.g., reception of a call signal, obtaining of a call signal) may be configured (or set) as a power control condition (e.g., SAR event) for the first antenna group 210. Upon identifying a call reception event, the processor 120 of the electronic device 101 may determine that the power control condition is satisfied, and may perform an SAR backoff operation based on the first antenna group 210. The processor 120 may adjust the transmission power (Tx power) applied to the first antenna group 210 to be less than a configured reference value (e.g., threshold value) so that an SAR value may be lowered. According to an embodiment, in response to satisfaction of the configured power control condition, the electronic device 101 may perform an SAR backoff operation (e.g., configuring transmission power (Tx power) to be less than a configured threshold value), and may reduce the strength of electromagnetic waves emitted from the electronic device 101.

According to an embodiment, upon call reception, the electronic device 101 may determine whether a power control condition (e.g., SAR event) is satisfied for each of the first antenna group 210 and the second antenna group 220, individually, and when the power control condition (e.g., SAR event) is satisfied, the electronic device 101 may perform an SAR backoff operation for the corresponding antenna group.

In operation 303, the processor 120 of the electronic device 101 may identify a power control condition (e.g., SAR event) configured (or set) for at least one antenna group (e.g., the first antenna group 210 and the second antenna group 220 of FIG. 2). For example, the processor 120 may configure (or set) a power control condition (e.g., SAR event) for each antenna group or for each antenna, individually. The processor 120 may configure (or set) a call reception event (e.g., RCV) as a power control condition for the first antenna group 210, and may configure (or set) a grip event (e.g., grip) as a power control condition for the second antenna group 220. According to an embodiment, the processor 120 may configure (or set) a plurality of situation conditions as a power control condition (e.g., SAR event), and may prioritize the situation conditions. For example, the processor 120 may identify, for the second antenna group 220, a grip event (e.g., grip) when a call reception event (e.g., RCV) occurs, and under the condition in which the call reception event and the grip event are identified together, may determine that the power control condition (e.g., SAR event) for the second antenna group 220 is satisfied.

In operation 305, the processor 120 may identify whether the electronic device 101 is gripped in a call reception situation. For example, when call reception is identified, the processor 120 may detect that an SAR event corresponding to the first antenna group 210 occurs. As another example, when a grip event is identified together with the call reception, the processor 120 may detect that an SAR event corresponding to the second antenna group 220 occurs.

According to an embodiment, based on a sensor module (e.g., sensor module 176 of FIG. 2), the electronic device 101 may identify whether the electronic device 101 is in a state of being gripped. According to an embodiment of the disclosure, the sensor module 176 may determine a grip state by detecting whether a user grips the electronic device 101. For example, the sensor module 176 may include at least one of a grip sensor, a speed sensor, a temperature sensor, an image sensor, a proximity sensor, or an infrared or ultraviolet sensor. According to an embodiment of the disclosure, gripping by the user may be determined by software. According to an embodiment of the disclosure, when call reception or call answering is performed, the electronic device 101 may determine that the electronic device 101 is gripped.

According to an embodiment, the processor 120 may identify an event with a high priority based on a configured power control condition (e.g., SAR event). For example, for the first antenna group 210, when a call reception event is configured (or set) to have a highest priority, the processor 120 may determine that the power control condition corresponding to the first antenna group 210 is satisfied when call reception is identified. As another example, for the second antenna group 220, when a grip event is configured (or set) to have a relatively higher priority than a call reception event, the processor 120 may determine that the power control condition corresponding to the second antenna group 220 is satisfied when a grip event is identified in the call reception state. Although the call is terminated during call reception in the state in which the electronic device 101 is gripped, the processor 120 may maintain an SAR backoff operation based on the second antenna group 220 since the grip event is maintained. According to an embodiment, the processor 120 may identify an event with a high priority for each of the plurality of antenna groups 210 and 220, and may determine whether to perform an SAR backoff operation based on the satisfaction of the power control condition.

In operation 307, the processor 120 may identify a power control condition corresponding to at least one of the first antenna group 210 and the second antenna group 220, and may identify that the power control condition is satisfied. According to an embodiment, the electronic device 101 may configure (or set) a power control condition (e.g., SAR event) for each antenna group 210 or 220 or for each antenna 211, 212, 221, or 222 individually, and may independently perform an SAR backoff operation according to the satisfaction of the power control condition. For example, the first antenna group 210 may be configured (or set) with a call reception event as a power control condition, and the second antenna group 220 may be configured (or set) with a grip event during call reception as a power control condition.

When a call reception event is identified, the processor 120 may perform an SAR backoff operation for the first antenna group 210. When a grip event is identified together with a call reception event, the processor 120 may perform an SAR backoff operation for the second antenna group 220.

In response to a situation in which the power control condition is satisfied, the processor 120 may adjust the transmission power (Tx power) of a signal transmitted via at least one antenna 211, 212, 221, or 222 included in the antenna group 210 or 220 in operation 309. The processor 120 may adjust the transmission power (Tx power) based on at least one antenna group (e.g., the first antenna group 210 and the second antenna group 220 of FIG. 2). For example, the processor 120 may adjust the transmission power (Tx power) to be lower according to a reference that complies with the SAR standard.

According to an embodiment, the processor 120 may identify whether a power control condition is satisfied (e.g., whether an SAR event occurs) for each of the first antenna group 210 and the second antenna group 220, individually, and when the power control condition is satisfied, the processor 120 may perform an SAR backoff operation for the corresponding antenna group, separately. For example, the processor 120 may perform an SAR backoff operation for the first antenna group 210, and at the same time, may not perform an SAR backoff operation for the second antenna group 220.

According to an embodiment of the disclosure, satisfaction of a power control condition may be configured (or set) to be different for each antenna. For example, an RCV-head condition (e.g., a case in which a user brings the electronic device 101 close to the head in a call reception state) may be configured (or set) for an upper side antenna, and a grip-non-head condition (e.g., a case in which a user does not bring the electronic device 101 close to the head while gripping the electronic device 101) may be configured (or set) for a lower side antenna. When a grip event for the lower side antenna is not identified in a call reception state (e.g., RCV operation), the electronic device 101 may not perform an SAR backoff operation for the lower side antenna. According to an embodiment, when a grip event for the lower side antenna is identified, the power control condition for the lower side antenna is satisfied, and thus the electronic device 101 may perform an SAR backoff operation for the lower side antenna.

Provided below is Table 2 in which an SAR value is configured (or set) to be different for each antenna according to a power control condition.

TABLE 2

| | Antenna group disposed | Antenna group disposed |
|---|---|---|
| | in upper side (e.g., | in lower side (e.g., |
| | first antenna group | second antenna group |
| | 210) | 220) |
| Call reception + | 18 dBm | 20 dBm |
| Grip state | | |
| Call reception | 18 dBm | 23 dBm |

Referring to Table 2, for example, when the electronic device 101 in a grip state is identified in a call reception state, the processor 120 may perform an SAR backoff operation for an antenna group (e.g., the first antenna group 210) disposed in an upper side. For example, the processor 120 may adjust the transmission power (Tx power) corresponding to the first antenna group 210 to be less than approximately 18 dBm.

Referring to Table 2, for example, when the electronic device 101 in a grip state is not identified in a call reception state, the processor 120 may perform an SAR backoff operation for the first antenna group 210, but may not perform an SAR backoff operation for the second antenna group 220. For example, the processor 120 may adjust the transmission power (Tx power) corresponding to the first antenna group 210 to be less than approximately 18 dBm, and may adjust the transmission power (Tx power) corresponding to the second antenna group 220 to be less than approximately 23 dBm.

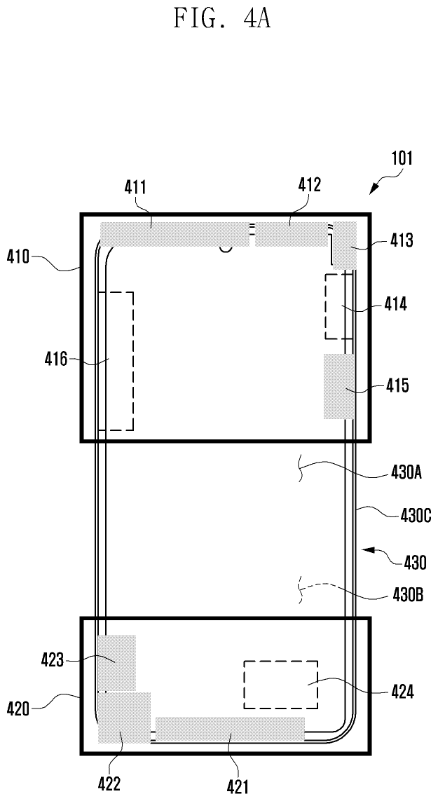

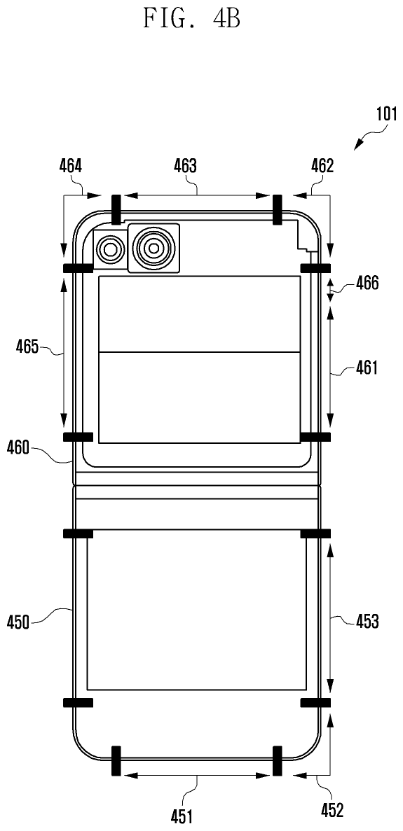

FIG. 4A is a diagram illustrating positions where a first antenna group and a second antenna group are disposed in an electronic device according to an embodiment of the disclosure. FIG. 4B is a diagram illustrating positions where a first antenna group and a second antenna group are disposed in a foldable electronic device (e.g., slidable electronic device) according to an embodiment of the disclosure.

Referring to FIG. 4A, the electronic device 101 according to an embodiment may include a housing 430 including a first side (front side) 430A, a second side (or rear side) 430B, and a lateral side 430C that encloses the space between the first side 430A and the second side 430B. According to another embodiment, a housing may refer to a structure that is a portion of the first side 430A, the second side 430B, and the lateral side 430C.

According to an embodiment, the housing 430 may include the main body of the electronic device 101, and may be divided as a first area 410 (e.g., upper side area, upper portion) and a second area 420 (e.g., lower side area, lower portion). For example, the first area 410 may include at least one antenna (e.g., the first antenna 211 and the second antenna 212 of FIG. 2) included in a first antenna group (e.g., the first antenna group 210 of FIG. 2) of the electronic device 101. For example, the second area 420 may include at least one antenna (e.g., the third antenna 221 and fourth antenna 222 of FIG. 2) included in a second antenna group (e.g., second antenna group 220 of FIG. 2) of the electronic device 101.

For example, the first area 410 may include a partial area of the electronic device 101 that is physically in contact with a body part (e.g., head, ear) of a user when call reception is performed. The first area 410 may include a speaker for outputting an audio signal based on call reception, and a proximity sensor for determining whether a body part of the user is near. The first area 410 may include a camera module for capturing an image. According to another embodiment, the camera module may be at least partially used as a proximity sensor.

For example, the second area 420 may include a partial area of the electronic device 101 disposed at least a selected distance away from a body part when call reception is performed. The second area 420 may include a microphone for obtaining a voice signal of the user in a call state. In a call reception situation, when the speaker is disposed close to an ear of the user, the microphone included in the second area 420 may be disposed close to the mouth of the user. According to an embodiment, when call reception is performed, the second area 420 may be disposed at least a selected distance away from the body part as compared to the first area 410, and a grip event may be considered a more important event than a call reception event.

According to an embodiment, the first area 410 may include at least one antenna classified as the first antenna group 210 (e.g., an antenna disposed in an upper side area of the electronic device 101). Referring to FIG. 4A, the first antenna group 210 may include a plurality of sub-antennas (e.g., sub-antenna 411, sub-antenna 412, sub-antenna 413, sub-antenna 414, sub-antenna 1-5 415, and sub-antenna 1-6 416). For example, the sub-antennas 411 to 416 may support different communication schemes.

According to an embodiment, the second area 420 may include at least one antenna classified as the second antenna group 220 (e.g., an antenna disposed in a lower side are of the electronic device 101). Referring to FIG. 4A, the second antenna group 220 may include a plurality of sub-antennas (e.g., sub-antenna 421, sub-antenna 422, sub-antenna 423, and sub-antenna 424). For example, the sub-antennas 421 to 424 may support different communication schemes.

Referring to FIG. 4A, first electromagnetic waves generated based on the first antenna group 210 (e.g., sub-antenna 411, sub-antenna 412, sub-antenna 413, sub-antenna 414, sub-antenna 415, and sub-antenna 416) disposed in the first area 410 may directly give harmful effects on a human body since the first area 410 is disposed to be physically in contact with the human body. Conversely, second electromagnetic waves generated based on the second antenna group 220 (e.g., sub-antenna 421, sub-antenna 422, sub-antenna 423, and sub-antenna 424) disposed in the second area 420 may give relatively less harmful effects on the human body since the second area 420 is disposed to be at least a selected distance away from the human body as compared with the first area 410.

According to an embodiment, upon identifying call reception, the electronic device 101 may perform an SAR backoff operation based on the first antenna group 210 included in the first area 410, or based on each antenna 411, 412, 413, 414, 415, or 416 included in the first antenna group 210. For example, the first antenna group 210 may be positioned relatively physically close to a human body when call reception is performed, and thus the electronic device 101 may perform an SAR backoff operation in response to the call reception.

According to an embodiment, upon identifying a grip event in a call reception situation, the electronic device 101 may perform an SAR backoff operation based on the second antenna group 220 included in the second area 420, or based on each antenna 421, 422, 423, or 424 included in the second antenna group 220. For example, the second antenna group 220 may perform an SAR backoff operation only when a grip event is identified in a call reception situation.

According to an embodiment, the processor 120 may identify whether a power control condition (e.g., SAR event) is satisfied for each of the first antenna group 210 and the second antenna group 220, individually, and when the power control condition is satisfied, the processor 120 may perform an SAR backoff operation for the corresponding antenna group, separately.

According to an embodiment, the electronic device 101 is not limited to a selected form embodied as the single housing 430, but may be implemented in various form factors (e.g., foldable electronic device, rollable electronic device, slidable electronic device, or wearable electronic device). For example, the electronic device 101 may include the first antenna group 210 that is in physical contact with a part of a human body or disposed within a selected distance when call reception is performed, and may include the second antenna group 220 disposed at least a selected distance away from the human body when call reception is performed. According to an embodiment, the electronic device 101 may configure (or set) an SAR event for each of the plurality of antenna groups 210 and 220, individually, and may independently perform an SAR backoff operation for each antenna group.

According to an embodiment of the disclosure, the electronic device 101, which is provided in a foldable structure, may perform an SAR backoff operation for an antenna group with a high SAR consumption margin, according to a folded state or an unfolded state. According to a folded state and an unfolded state, a power control condition or a control operation associated with SAR backoff may be configured (or set) to be different.

Referring to FIG. 4B, the electronic device 101 may include a foldable electronic device, and may be configured (or set) with a first housing 450 and a second housing 460. For example, the foldable electronic device 101 may include at least one antenna (e.g., sub-antenna 451, sub-antenna 452, or sub-antenna 453) classified as a third antenna group based on the first housing 450. For example, the foldable electronic device 101 may include at least one antenna (e.g., sub-antenna 461, sub-antenna 462, sub-antenna 463, sub-antenna 464, sub-antenna 465, or sub-antenna 466) classified as a fourth antenna group based on the second housing 460.

According to an embodiment, the foldable electronic device 101 may configure (or set) a power control condition to be different for each of the third antenna group and the fourth antenna group, and may configure (or set) a control operation associated with SAR backoff to be different for each case. According to an embodiment, the foldable electronic device 101 may configure (or set) the control operation to fall within a power control condition in association with a folded state and an unfolded state.

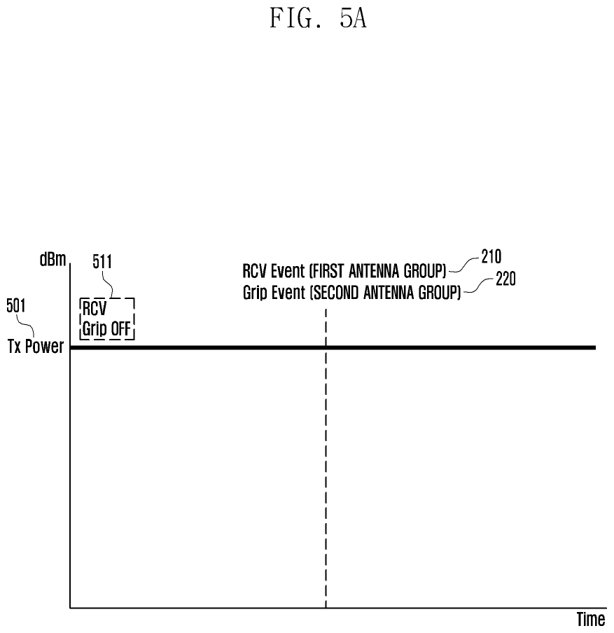

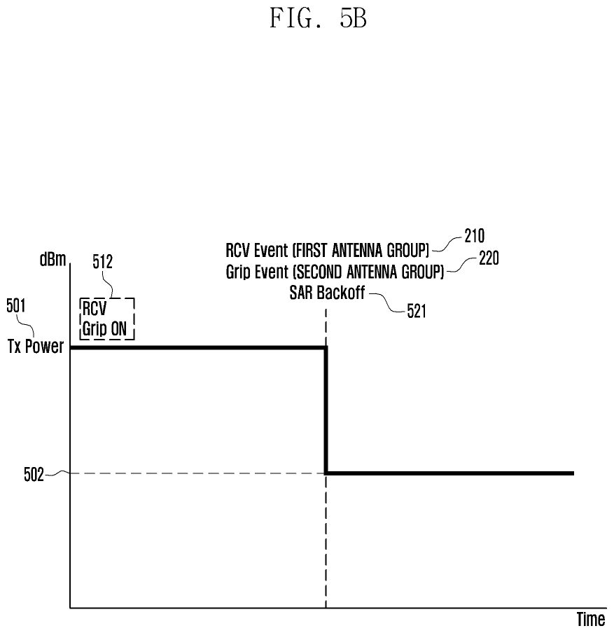

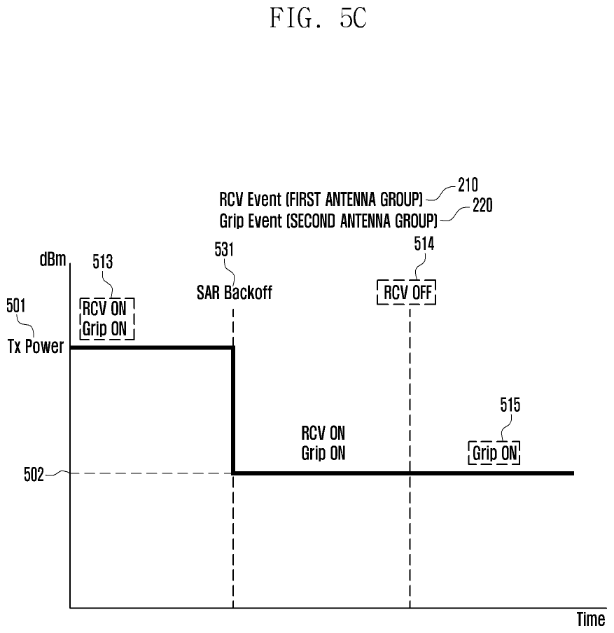

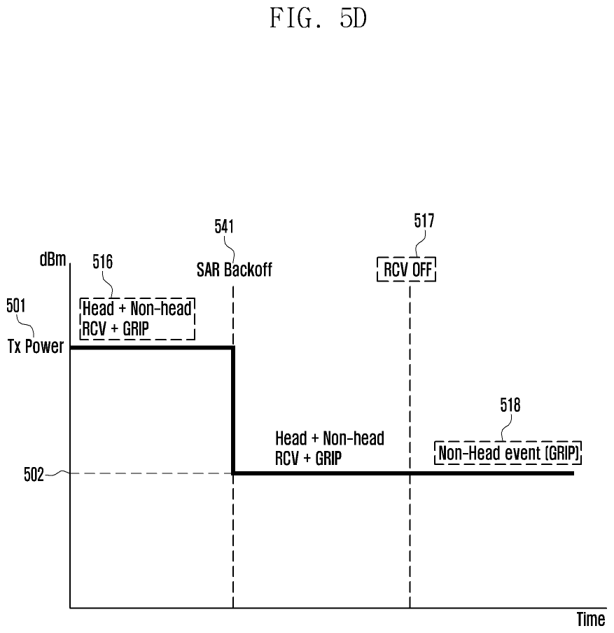

FIG. 5A is a first graph representing an SAR value when no grip event occurs in a call reception situation according to an embodiment of the disclosure. FIG. 5B is a second graph representing an SAR value when a grip event occurs in a call reception situation according to an embodiment of the disclosure. FIG. 5C is a third graph representing an SAR value when call reception is terminated in a situation in which an SAR backoff operation occurs in response to call reception according to an embodiment of the disclosure.

The electronic device 101 of FIGS. 5A, 5B, and 5C (e.g., electronic device 101 of FIG. 1) may be at least partially similar to the electronic device 101 of FIGS. 1 and 2, or may further include other embodiments of the electronic device 101. The electronic device 101 may include a plurality of antenna groups (e.g., the first antenna group 210, second antenna group 220 of FIG. 2). The first antenna group 210 of the plurality of antenna groups 210 and 220 may include at least one first antenna (e.g., the first antenna 211 of FIG. 2), and the second antenna group 220 may include at least one second antenna (e.g., the third antenna 221 of FIG. 2).

According to an embodiment, the first antenna group 210 may be disposed based on the first area 410 (e.g., upper side area, upper portion) of a housing (e.g., the housing 430 of FIG. 4A) of the electronic device 101, and may be configured (or set) with a call reception event (e.g., RCV event) as a power control condition (e.g., SAR event). For example, the call reception event may include a situation in which a call request signal is received or a situation in which a voice signal is received via an audio module (e.g., the audio module 170 of FIG. 1, microphone). According to an embodiment, the second antenna group 220 may be disposed based on the second area 420 (e.g., lower side area, lower portion) in the housing 430, and may be configured (or set) with a grip event (e.g., Grip event) in a call reception situation as a power control condition (e.g., SAR event).

FIGS. 5A and 5B illustrate first transmission power 501 (e.g., Tx power, SAR value) supplied to the second antenna group 220 based on the first antenna group 210 configured (or set) with a call reception event (e.g., RCV event) as a power control condition and the second antenna group 220 configured (or set) with a grip event (e.g., Grip event) in a call reception situation as a power control condition.

FIG. 5A is a first graph illustrating the first transmission power 501 of a signal transmitted via the second antenna group 220 in a state 511 in which a call reception event (e.g., RCV) is identified but a grip event is not identified (e.g., grip OFF).

Referring to FIG. 5A, the processor 120 of the electronic device 101 may be in a state of performing an SAR backoff operation in relation to the first antenna group 210 due to a call reception event (e.g., RCV event). In relation to the second antenna group 220, the processor 120 may not perform an SAR backoff operation since a grip event (e.g., Grip event) is not identified in a call reception event (e.g., RCV event). The electronic device 101 of FIG. 5A may not perform an SAR backoff operation for the second antenna group 220.

FIG. 5B is a second graph illustrating a second transmission power 502 of a signal transmitted via the second antenna group 220 in a state 512 in which a call reception event (e.g., RCV event) and a grip event (e.g., grip ON) are identified together.

Referring to FIG. 5B, the processor 120 of the electronic device 101 may be in a state of performing an SAR backoff operation in association with the first antenna group 210 due to a call reception event (e.g., RCV event). In relation to the second antenna group 220, the processor 120 may perform an SAR backoff operation 521 for the second antenna group 220 since a grip event (e.g., Grip event) is identified in a call reception event (e.g., RCV event). The electronic device 101 of FIG. 5B may perform an SAR backoff operation 521 for the second antenna group 220, and may supply the second transmission power 502 to the second antenna group 220. For example, the SAR backoff operation 521 may include an operation of adjusting the first transmission power 501 supplied to the second antenna group 220 to the second transmission power 502.

FIG. 5C is a third graph illustrating the second transmission power 502 of a signal transmitted via the second antenna group 220, in response to a situation 514 (e.g., RCV OFF) in which a call reception event is terminated while the SAR backoff operation 521 of the second graph of FIG. 5B is being performed.

Referring to FIG. 5C, the first transmission power 501 of the signal transmitted via the second antenna group 220 in a state 513 in which a call reception state (e.g., RCV ON) is identified and a grip event (e.g., Grip ON) is identified together. For example, the processor 120 of the electronic device 101 may perform an SAR backoff operation 531 for the second antenna group 220, and may adjust the first transmission power 501 supplied to the second antenna group 220 to the second transmission power 502. Although the situation 514 in which a call reception event is terminated is identified in a situation in which the second transmission power 502 is supplied to the second antenna group 220, the processor 120 may maintain the SAR backoff operation 531 for the second antenna group 220. For example, in the case of the second antenna group 220, a grip event may be configured (or set) with a higher priority than a call reception event, and the SAR backoff operation 531 for the second antenna group 220 may be maintained in response to a situation 515 in which the grip event is identified (e.g., maintained).

FIG. 5D is a fourth graph representing an SAR value when call reception is terminated in a situation (e.g., a state in which both a head event and a non-head event are configured or set) in which an SAR backoff operation occurs in response to call reception according to an embodiment of the disclosure.

The electronic device 101 of FIG. 5D may be at least partially similar to the electronic device 101 of FIGS. 1 and 2, or may further include other embodiments of the electronic device 101. The electronic device 101 of FIG. 5D may be similar to the electronic device 101 mentioned in FIGS. 5A, 5B, and 5C.

According to an embodiment, the processor 120 of the electronic device 101 may identify that a head event occurs when the electronic device 101 is disposed close to the head of a user physically within a selected distance. The processor 120 may identify a non-head event when the electronic device 101 is disposed physically at least a selected distance away from the head of the user. For example, when a call reception event is identified, it is determined that a head event occurs, and when a call termination event is identified, it is determined that a non-head event occurs.

Referring to FIG. 5D, the electronic device 101 may configure (or set) both a head event and a non-head event. In response to a situation 516 in which a reception event (RCV) and a grip event (e.g., Grip ON or Grip OFF) are identified together, the processor 120 may perform an SAR backoff operation 541 for the second antenna group 220. The processor 120 may adjust, to the second transmission power 502, the first transmission power 501 of a signal transmitted via the second antenna group 220.

Referring to FIG. 5D, although a situation 517 (RCV OFF) in which a call reception event is terminated is identified in a situation in which the second transmission power 502 is supplied to the second antenna group 220, the processor 120 may maintain the SAR backoff operation 541 for the second antenna group 220. For example, the electronic device 101 may be configured (or set) with both the head event and the non-head event, and thus may identify that a non-head event 518 (e.g., Non-Head event (GRIP)) may be configured (or set) even in the situation 517 in which the call reception event is terminated, and may prevent the SAR backoff operation 541 from being cancelled. According to an embodiment, although the situation of call termination is identified during call reception in a grip state, the electronic device 101 may maintain the SAR backoff operation.

According to an embodiment, the electronic device 101 may perform an SAR backoff operation for each of the plurality of antenna groups 210 and 220, individually, and may determine whether to maintain or cancel the SAR backoff operation in consideration of various situations. According to an embodiment, the electronic device 101 may reduce situations violating the SAR standard (e.g., SAR regulations), and may prevent situations causing harmful effects to the human body. Safety associated with the use of the electronic device 101 may be improved.

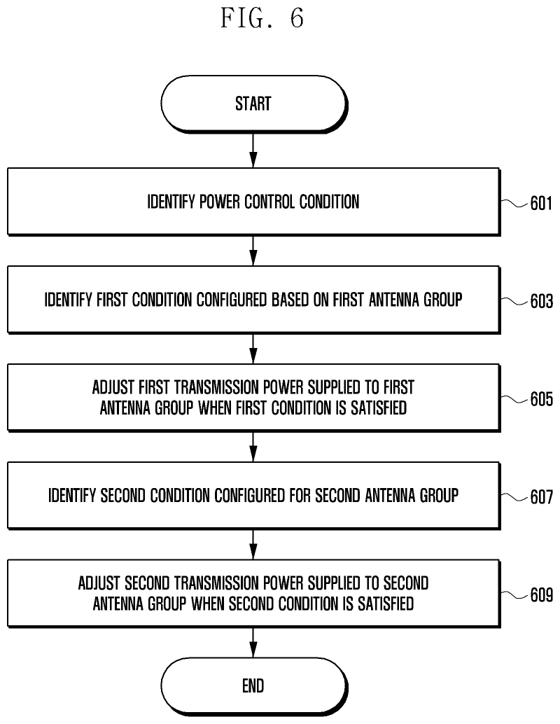

FIG. 6 is a flowchart illustrating a method of identifying an SAR event for each antenna group according to an embodiment of the disclosure.

In the following embodiment, operations may be performed sequentially, but the order is not necessarily sequential. For example, the order of operations may be changed, and at least two operations may be performed in parallel.

According to an embodiment, it may be understood that operations 601 to 609 are performed by a processor (e.g., the processor 120 of FIGS. 1 and 2) of an electronic device (e.g., the electronic device 101 of FIGS. 1 2).

The electronic device 101 of FIG. 6 may be at least partially similar to the electronic device 101 of FIG. 1, or may further include other embodiments of the electronic device 101. The electronic device 101 may include a plurality of antenna groups (e.g., the first antenna group 210 and the second antenna group 220 of FIG. 2), and may determine whether to perform an SAR backoff operation based on at least one of the antennas included in the plurality of antenna groups 210 and 220.

According to an embodiment, the electronic device 101 may configure (or set) a power control condition (e.g., SAR event) to be different for each of the plurality of antenna groups 210 and 220. For example, the power control condition (e.g., SAR event) may be a reference condition for performing an SAR backoff operation.

For example, a call reception event (e.g., reception of a call signal, obtaining of a call signal) may be configured (or set) as a first condition (e.g., first power control condition) for the first antenna group 210. When the first condition (e.g., call reception event) is satisfied, the processor 120 of the electronic device 101 may perform an SAR backoff operation based on the first antenna group 210. The processor 120 may adjust the transmission power (Tx power) of a signal transmitted via the first antenna group 210 to a first transmission power (e.g., a value less than a configured SAR value). According to an embodiment, the processor 120 may adjust the power of a signal transmitted via the first antenna group 210 to the first transmission power, and may reduce the strength of electromagnetic waves generated from the first antenna group 210.

For example, a grip event (e.g., situation in which the electronic device 101 is disposed close to an ear of a user in a call reception situation) may be configured (or set) as a second condition (e.g., second power control condition) for the second antenna group 220. When the second condition (e.g., grip event) is satisfied, the processor 120 of the electronic device 101 may perform an SAR backoff operation based on the second antenna group 220. The processor 120 may adjust the transmission power (Tx power) of a signal transmitted via the second antenna group 220 to a second transmission power (e.g., a value less than a configured SAR value). According to an embodiment, the processor 120 may adjust the power of a signal transmitted via the second antenna group 220 to the second transmission power, and may reduce the strength of electromagnetic waves generated from the second antenna group 220.

In operation 601, the processor 120 may identify a power control condition. For example, the power control condition (e.g., SAR event) may be a trigger condition for determining whether to perform an SAR backoff operation, and may include a call reception event and a grip event. The power control condition (e.g., SAR event) may include an event that causes harmful effects to a user due to electromagnetic waves generated from the electronic device 101.

In operation 603, the processor 120 may identify the first condition (e.g., first power control condition) configured (or set) based on the first antenna group 210. For example, the processor 120 may be in a state in which a call reception event is already configured (or set) as the first condition for the first antenna group 210. When the first condition identified in operation 603 is a call reception event, the processor 120 may adjust the first transmission power supplied to the first antenna group 210 in response to satisfaction of the first condition in operation 605. The processor 120 may perform an SAR backoff operation for the first antenna group 210.

In operation 605, the processor 120 may adjust the first transmission power of a signal transmitted via the first antenna group 210 based on the identified first condition (e.g., call reception event). For example, the processor 120 may apply, to the first antenna group 210, the first transmission power (Tx power) corresponding to the first condition, and may comply with the SAR standard (e.g., SAR regulations).

In operation 607, the processor 120 may identify the second condition (e.g., second power control condition) configured (or set) based on the second antenna group 220. For example, the processor 120 may be in a state in which a grip event (e.g., a situation in which a grip event occurs in a call reception state) is already configured (or set) as the second condition for the second antenna group 220. When the second condition identified in operation 607 is a grip event, the processor 120 may adjust the second transmission power supplied to the second antenna group 220 in operation 609. The processor 120 may perform an SAR backoff operation for the second antenna group 220.

In operation 609, the processor 120 may adjust the second transmission power of a signal transmitted via the second antenna group 220 based on the identified second condition (e.g., grip event). For example, the processor 120 may apply, to the second antenna group 220, the second transmission power (Tx power) corresponding to the second condition, and may comply with the SAR standard (e.g., SAR regulations).

According to an embodiment, the processor 120 may identify whether an SAR event occurs (e.g., is satisfied) for each of the first antenna group 210 and the second antenna group 220, individually, and when an SAR event occurs, the processor 120 may perform an SAR backoff operation for the corresponding antenna group, separately.

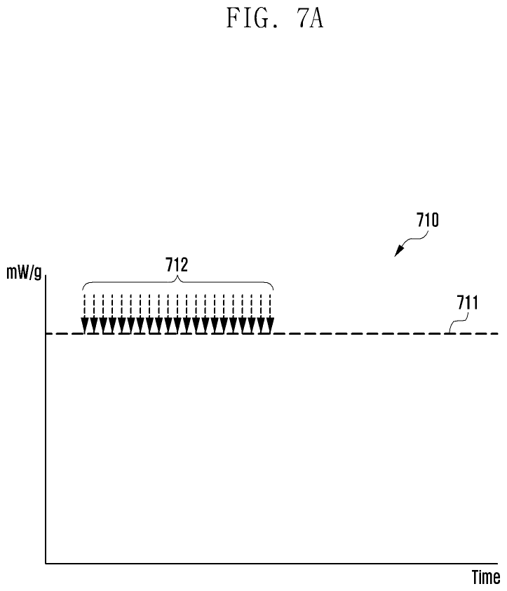

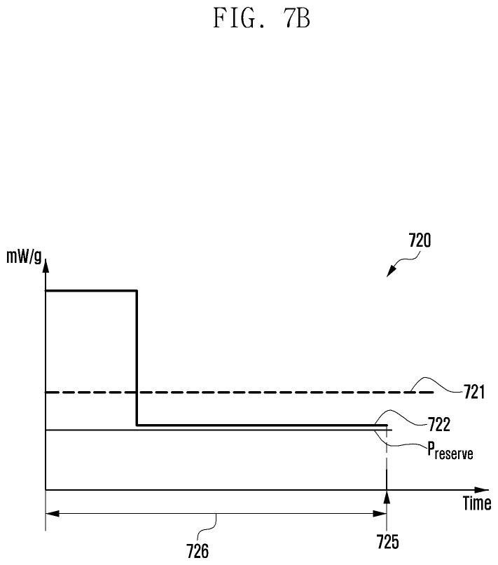

FIG. 7A is a first graph illustrating a power control condition based on a fixed value in relation to SAR regulations according to an embodiment of the disclosure. FIG. 7B is a second graph illustrating a power control condition based on an average value in relation to SAR regulations according to an embodiment of the disclosure.

FIG. 7A illustrates a first graph 710 according to a first power control scheme in which a power control condition is configured (or set) based on a fixed value (e.g., SAR limit). For example, the electronic device 101 (e.g., electronic device 101 of FIG. 1) may configure (or set) a first threshold value 711 related to SAR as a first power control condition. For example, the first threshold value 711 may be determined based on a fixed reference value. A processor (e.g., processor 120 of FIG. 1) of the electronic device 101 may control transmission power (Tx power) so that a first SAR value based on electromagnetic waves may not exceed the first threshold value 711, when emitting electromagnetic waves via at least one antenna. According to an embodiment, the first SAR value based on electromagnetic waves is a value for continuously controlling, based on the fixed reference, the transmission power (Tx power) during a selected time interval 712, and may not exceed the first threshold value 711.

According to an embodiment, when performing communication, the first power control scheme based on FIG. 7A (e.g., a scheme of configuring a power control condition related to SAR based on a fixed value) may control transmission power (Tx power) under the condition in which the first threshold value 711 is not exceeded.

FIG. 7B illustrates a second graph 720 according to a second power control scheme in which a power control condition is configured (or set) based on an average value (e.g., power limit (Plimit)). For example, as a second power control condition, the electronic device 101 may configure (or set) a second threshold value 721 related to SAR based on an average value of SAR values. For example, the second threshold value 721 may be determined based on an average transmission power value. When emitting electromagnetic waves via at least one antenna, the processor 120 may control transmission power (Tx power) so that an average value 722 of second SAR values generated by electromagnetic waves may not exceed the second threshold value 721. According to an embodiment, the average value 722 of second SAR values by electromagnetic waves may be the average value 722 of the second SAR values generated based on transmission power (Tx power) during a selected period of time 726. According to an embodiment, when performing communication, the second power control scheme based on FIG. 7B (e.g., a scheme of configuring a power control condition related to SAR based on an average value) may control transmission power (Tx power) under the condition in which the second threshold value 721 is not exceeded.

According to an embodiment of the disclosure, the second power control scheme (time average SAR (TAS)) (e.g., second graph 720) may calculate average transmission power (Tx power) 722 during the selected time 726, and may control transmission power (Tx power) so that the calculated average transmission power (Tx power) may not exceed the second threshold value 721 (e.g., SAR reference (SAR limit)). The TAS scheme (e.g., second power control scheme) may control transmission power (Tx power) so that the average value 722 of the second SAR values may not exceed the second threshold value 721 (e.g., power limit (Plimit) value).

According to an embodiment, the first power control scheme (e.g., first graph 710) may immediately perform an SAR backoff operation when transmission power (Tx power) is greater than the first threshold value 711. Conversely, the second power control scheme (e.g., second graph 720) may identify an average value of second SAR values when transmission power (Tx power) is greater than the second threshold value 721, and may not perform an SAR backoff operation when the average value is less than the second threshold value 721. According to an embodiment of the disclosure, the second power control scheme (e.g., second graph 720) may configure (or set) a reserve power Preserve related to transmission power, and may ensure the average value of the second SAR values so as not to drop the power below a selected level (e.g., the reserve power Preserve). The second power control scheme (e.g., second graph 720) may prevent disconnection of call reception.

An operation method of an electronic device (e.g., the electronic device 101 of FIG. 1) according to an embodiment may include an operation of identifying a grip state of the electronic device 101 based on a sensor module (e.g., the sensor module 176 of FIG. 1) in response to call reception, an operation of identifying, based on the identified grip state, whether a power control condition corresponding to at least one of the first antenna group (e.g., the first antenna group 210 of FIG. 2) and the second antenna group (e.g., the second antenna group 220 of FIG. 2) is satisfied, when call reception is performed, and in response to a situation in which the power control condition is satisfied, an operation of adjusting a transmission power (Tx power) of a signal transmitted via at least one antenna included in an antenna group that satisfies the power control condition.

The method according to an embodiment may further include an operation of identifying a first power control condition configured (or set) for at least one first antenna (e.g., the first antenna 211 of FIG. 2) included in the first antenna group 210, and an operation of determining, based on the state of the electronic device 101, whether the first antenna group 210 satisfies the first power control condition when call reception is performed.

The method according to an embodiment may further include an operation of identifying a second power control condition configured (or set) for at least one second antenna (e.g., the third antenna 221 of FIG. 2) included in the second antenna group 220, and an operation of determining, based on the state of the electronic device 101, whether the second antenna group 220 satisfies the second power control condition when call reception is performed.

The method according to an embodiment may further include an operation of determining first transmission power to be less than a configured SAR threshold value when the first power control condition corresponding to the first antenna group 210 is satisfied; and an operation of transmitting a signal having the first transmission power via the at least one first antenna 211 included in the first antenna group 210.

The method according to an embodiment may further include, when the second power control condition corresponding to the second antenna group 220 is satisfied, an operation of determining second transmission power to be less than a configured SAR threshold value, and an operation of transmitting a signal having the second transmission power via the at least one second antenna 221 included in the second antenna group 220.

According to an embodiment, the operation of adjusting the transmission power (Tx power) may include an operation of identifying whether the electronic device 101 is in a grip state when performing the call reception, by using a grip sensor included in the sensor module 176, and an operation of adjusting a transmission power (Tx power) of a signal transmitted via at least one antenna included in the first antenna group 210 and the second antenna group 220 in response to the grip state.

The method according to an embodiment may further include an operation of identifying call termination in a situation in which a signal having the adjusted transmission power (Tx power) is transmitted via the at least one antenna, and an operation of maintaining the transmission power (Tx power) of the signal transmitted via the at least one antenna in response to the grip state being maintained.

According to an embodiment, the call reception may include a first condition in which the electronic device 101 is disposed within a configured distance from the head of a user, and the call termination may include a second condition in which the electronic device 101 is disposed at least (or outside) a configured distance away from the head of the user.

The method according to an embodiment may further include an operation of configuring the first condition and the second condition together as the power control condition, an operation of adjusting the transmission power (Tx power) of a signal transmitted via the at least one antenna in response to the call reception, and an operation of maintaining the adjusted transmission power (Tx power) of a signal transmitted via the at least one antenna in response to the call termination.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. It is intended that features described with respect to separate embodiments, or features recited in separate claims, may be combined unless such a combination is explicitly specified as being excluded or such features are incompatible. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
at least one first antenna included in a first antenna group;
at least one second antenna included in a second antenna group different from the first antenna group;
a communication circuit operatively connected to the at least one first antenna and the at least one second antenna;
a sensor;
a memory storing instructions; and
at least one processor connected to the communication circuit, the sensor, and the memory,
wherein the instructions, when executed by the at least one processor individually or collectively, cause the electronic device to:
identify, by using the sensor, a state of the electronic device, based on a call reception via the communication circuit;
during the call reception, identify whether a power control condition configured for at least one of the first antenna group and the second antenna group is satisfied, based on the state of the electronic device; and
based on identifying that the power control condition is satisfied, adjust a transmission power of a signal transmitted via at least one antenna included in an antenna group that satisfies the power control condition from among the first antenna group or the second antenna group.

2. The electronic device of claim 1, wherein the instructions, when executed by the at least one processor individually or collectively, cause the electronic device to:
identify a first power control condition configured for the at least one first antenna included in the first antenna group; and
during the call reception, identify, based on the state of the electronic device, whether the first antenna group satisfies the first power control condition.

3. The electronic device of claim 2, wherein the instructions, when executed by the at least one processor individually or collectively, cause the electronic device to:
identify a second power control condition configured for the at least one second antenna included in the second antenna group; and
during the call reception, identify, based on the state of the electronic device, whether the second antenna group satisfies the second power control condition.

4. The electronic device of claim 3, wherein the instructions, when executed by the at least one processor individually or collectively, cause the electronic device to:
based on identifying that the first power control condition configured for the first antenna group is satisfied, identify that a first transmission power is less than a configured specific absorption rate (SAR) threshold value; and
transmit a signal having the first transmission power via the at least one first antenna included in the first antenna group.

5. The electronic device of claim 4, wherein the instructions, when executed by the at least one processor individually or collectively, cause the electronic device to:
based on identifying that the second power control condition corresponding to the second antenna group is satisfied, identify that a second transmission power is less than a configured SAR threshold value; and
transmit a signal having the second transmission power via the at least one second antenna included in the second antenna group.

6. The electronic device of claim 1, wherein the sensor further comprises a grip sensor, and the state of the electronic device comprises a grip state in which a user grips the electronic device,
wherein the instructions, when executed by the at least one processor individually or collectively, cause the electronic device to:
identify, using the grip sensor, whether the electronic device is in the grip state during the call reception; and
based on identifying that the electronic device is in the grip state, adjust a transmission power of a signal transmitted via at least one antenna included in the first antenna group and the second antenna group.

7. The electronic device of claim 6, wherein the instructions, when executed by the at least one processor individually or collectively, cause the electronic device to:
identify call termination in a situation in which a signal having the adjusted transmission power is transmitted via the at least one antenna; and
based on the grip state being maintained, maintain the transmission power of the signal transmitted via the at least one antenna.

8. The electronic device of claim 7, wherein the call reception comprises a first condition in which the electronic device is positioned within a configured distance from a head of a user, and
wherein the call termination comprises a second condition in which the electronic device is positioned at least the configured distance away from the head of the user.

9. The electronic device of claim 8, wherein the instructions, when executed by the at least one processor individually or collectively, cause the electronic device to:
configure the first condition and the second condition together as the power control condition;
based on the call reception, adjust the transmission power of a signal transmitted via the at least one antenna; and
based on the call termination, maintain the adjusted transmission power of a signal transmitted via the at least one antenna.

10. The electronic device of claim 9, wherein the first antenna group comprises the at least one first antenna that, during the call reception, is positioned within the configured distance from the head of the user, in the grip state, and
wherein the second antenna group comprises the at least one second antenna that, during the call reception, is positioned at least the configured distance away from the head of the user, in the grip state.

11. The electronic device of claim 1, wherein the power control condition is individually configured for each of the first antenna group and the second antenna group, and
wherein the instructions, when executed by the at least one processor individually or collectively, cause the electronic device to, based on the power control condition being satisfied, adjust a transmission power supplied to the at least one antenna, independently.

12. A method of operating an electronic device, the method comprising:
based on a call reception, identifying a grip state of the electronic device, using a sensor of the electronic device;
during the call reception, identifying whether a power control condition configured for at least one of a first antenna group and a second antenna group of the electronic device is satisfied, based on the identified grip state; and
based on identifying that the power control condition is satisfied, adjusting a transmission power of a signal transmitted via at least one antenna included in an antenna group that satisfies the power control condition from among the first antenna group and the second antenna group.

13. The method of claim 12, further comprising:
identifying a first power control condition configured for at least one first antenna included in the first antenna group;
during the call reception, identifying whether the first antenna group satisfies the first power control condition, based on the grip state of the electronic device;
based on identifying that the first power control condition configured for the first antenna group is satisfied, identifying that a first transmission power is less than a configured SAR threshold value; and
transmitting a signal having the first transmission power via the at least one first antenna included in the first antenna group.

14. The method of claim 13, further comprising:
identifying a second power control condition configured for at least one second antenna included in the second antenna group;
during the call reception, identifying whether the second antenna group satisfies the second power control condition, based on the grip state of the electronic device;
based on identifying that the second power control condition configured for the second antenna group is satisfied, identifying that a second transmission power is less than a configured SAR threshold value; and
transmitting a signal having the second transmission power via the at least one second antenna included in the second antenna group.

15. The method of claim 12, wherein the sensor comprises a grip sensor, and
wherein the adjusting of the transmission power comprises:
during the call reception, identifying, using the grip sensor, whether the electronic device is in the grip state; and
based on identifying that the electronic device is in the grip state, adjusting a transmission power of a signal transmitted via at least one antenna included in the first antenna group and the second antenna group.

16. The method of claim 12, further comprising:
identifying call termination in a situation in which a signal having the adjusted transmission power is transmitted via the at least one antenna; and
based on the grip state being maintained, maintaining the transmission power of the signal transmitted via the at least one antenna.

17. The method of claim 12,
wherein the call reception comprises a first condition in which the electronic device is positioned within a configured distance from a head of a user, and
wherein the call termination comprises a second condition in which the electronic device is positioned at least the configured distance away from the head of the user.

18. The method of claim 12, further comprising:
configuring the first condition and the second condition together as the power control condition;
based on the call reception, adjusting the transmission power of a signal transmitted via the at least one antenna; and
based on the call termination, maintaining the adjusted transmission power of the signal transmitted via the at least one antenna.

19. The method of claim 12,
wherein the first antenna group comprises the at least one first antenna that, during the call reception, is positioned within the configured distance from the head of the user, in the grip state, and
wherein the second antenna group comprises the at least one second antenna that, during the call reception, is positioned at least the configured distance away from the head of the user, in the grip state.

20. One or more non-transitory computer-readable storage media storing one or more computer programs including computer-executable instructions that, when executed by at least one processor of an electronic device individually or collectively, cause the electronic device to perform operations comprising:
based on a call reception, identifying a grip state of the electronic device, using a sensor of the electronic device;
during the call reception, identifying whether a power control condition configured for at least one of a first antenna group and a second antenna group of the electronic device is satisfied, based on the identified grip state; and
based on identifying that the power control condition is satisfied, adjusting a transmission power of a signal transmitted via at least one antenna included in an antenna group that satisfies the power control condition from among the first antenna group and the second antenna group.
